(19) United States
(12) Patent Application Publication
(10) Pub. No.: US 2013/0124539 A1
(43) Pub. Date: May 16, 2013

(54) PERSONAL RELEVANCY CONTENT RESIZING

(71) Applicants: Andrew C. Lin, San Francisco, CA (US); Eric I. Feng, Menlo Park, CA (US); Eugene C. Wei, San Francisco, CA (US)

(72) Inventors: Andrew C. Lin, San Francisco, CA (US); Eric I. Feng, Menlo Park, CA (US); Eugene C. Wei, San Francisco, CA (US)

(73) Assignee: Airtime Media, Inc., San Francisco, CA (US)

(21) Appl. No.: 13/614,895

(22) Filed: Sep. 13, 2012

Related U.S. Application Data
(60) Provisional application No. 61/534,167, filed on Sep. 13, 2011.

(51) Int. Cl. G06F 17/30

(52) U.S. Cl. 707/749

(57) ABSTRACT

Described is a technique for resizing content items in a social network based on a relevancy of the content items to a user in the social network. In the disclosed technique, content items that are relevant to the user are identified and a relevancy score for each of the content items is computed based on factors including, number of interactions with the content items by a user, type of interactions and a type of user. A display size of the content item is determined based on the relevancy score of the content item. The display size can be directly proportional to the relevancy score of content item. The content items are generated based on the determined size and displayed to the user. Accordingly, a content item which is more relevant to the user is displayed at a bigger size than a content item which is less relevant to the user.

### CROSS-REFERENCE TO RELATED APPLICATIONS

This application claims the benefit of priority under 35 U.S.C. 119(e) to U.S. Provisional Patent Application Ser. No. 61/534,167 entitled “PERSONAL RELEVANCY CONTENT RESIZING”, which was filed on Sep. 13, 2011, the contents of which are expressly incorporated by reference herein.

### FIELD OF THE INVENTION

This invention generally relates to organizing content in a social network. More specifically, the invention relates to resizing of contents in the social network based on their relevancy to a user in the social network.

### BACKGROUND

In a social network, content is shared between a number of entities. The entities may include people, organizations, institutions, businesses, services, etc. The content includes a picture, video, audio, animation, text, etc. The users may view the content that is shared with them and also the content that is not shared with them. The content viewed by a particular user in the social network may or may not be relevant to the user. For example, content shared by the user may be more relevant to the user than content shared with the user by another user. However, prior social network applications display the content that is not relevant or less relevant to the user in a way similar to the content that is more relevant to the user. Accordingly, the user may not be able to distinguish between the content that is not relevant or less relevant to the user and the content that is more relevant to the user. Thus, the prior social network applications are not adept at providing a good user experience to the user for viewing the content.

### SUMMARY

What is described is a technique for resizing content items in a social network based or the relevancy of the content items to a particular user in the social network. In the disclosed technique content items that are relevant to the user are identified and a relevancy score for each of the content items is computed based on a number of factors. Further, a display size of each of the content items is determined based on their corresponding relevancy scores. The display size can be directly proportional to the relevancy score of the content item. The content items are generated at the determined size and displayed to the user. Accordingly, a content item which is more relevant to the user is generated or displayed at a bigger display size than the content item which is less relevant to the user.

The disclosed technique also includes resizing displayed content, such as a 2-dimensional rectangular content card, based on a calculation of the relevancy of that content to the user viewing it. The area of the card, calculated as a product of the width and height of the card, is larger higher the relevancy of the card is to the user. In some embodiments, other adjacently and/or otherwise contemporaneously displayed items of content that have less relevance to the viewing user are displayed in a smaller size than the content that is determined to be more relevant to the viewing user.

In at least some embodiments, the relevancy score of a content item for a user is calculated based on relevancy factors including at least one of (a) the user's direct interaction or association with that content item (b) interaction with that content item by entities in the user's social graph, or (c) interaction with that content item by entities that are not in the user's social graph.

Some embodiments of the invention have other aspects, elements, features, and steps in addition to or in place of what is described above. These potential additions and replacements are described throughout the rest of the specification.

### BRIEF DESCRIPTION OF THE DRAWINGS

FIG. 1 illustrates an environment in which an embodiment of the disclosed technique can operate.

FIG. 2 is a block diagram illustrating a system that generates content items with display sizes determined based on a relevancy score of the content items.

FIG. 3 is a flow diagram illustrating a process for generating content items with display sizes determined based on a relevancy score of the content items.

FIG. 4 is an example illustrating content items generated with display sizes determined based on a relevancy score of the content items to a first user.

FIG. 5 is an example illustrating content items of FIG. 4 generated with display sizes determined based on a relevancy score of the content items to a second user.

FIG. 6 is a block diagram of an apparatus that may perform various operations, and store various information generated and/or used by such operations.

### DETAILED DESCRIPTION

The following description and drawings are illustrative and are not to be construed as limiting. Numerous specific details are described to provide a thorough understanding of the disclosure. However, in certain instances, well-known or details are not described in order to avoid obscuring the description.

References in this description to “an embodiment”, “one embodiment”, or the like, mean that the particular feature, function, or characteristic being described is included in at least one embodiment of the present invention. Occurrences of such phrases in this specification do not necessarily all refer to the same embodiment, nor are they necessarily mutually exclusive.

Disclosed is a technique for resizing content items in a social network based on the relevancy of the content items to a particular user in the social network. In the disclosed technique content items that are relevant to the user are identified and a relevancy score for each of the content items is computed based on a number of factors. Further, a display size of each of the content items is determined based on the relevancy score of the content items. The display size can be directly proportional to the relevancy score of the content item. The content items are generated based on the determined size and displayed to the user. Accordingly, a content item which is more relevant to the user is generated in a bigger display size than the content item which is less relevant to the user.

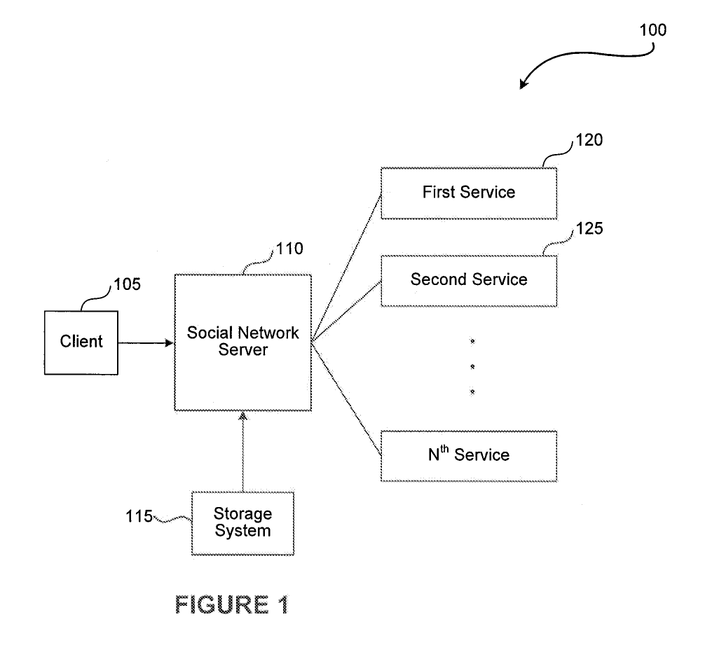

FIG. 1 illustrates an environment 100 in which an embodiment of the disclosed technique can operate. The environment 100 includes a social networking server (or server) 110 in a social network that provides social networking services to a user such as, client 105. The server 110 allows the client 105 to perform activities such as, posting content items, sharing content items, commenting on content items, “liking” content items indicating that a particular content item is of special interest to the user 105, marking content items as a favorite, chatting with other clients etc. The server 110 may store the content items of the users in a storage system 115.

The server 110 is also configured to communicate with other external services such as first service 120, a second service 125 and so on to obtain content items that are relevant to the user from the external services. The external services may include other social networking services such as, Facebook® available from Facebook of Menlo Park, Calif.; Google+® or g+® available from Google, Inc. of Mountain View, Calif., Tagged® available from Tagged, Inc. of San Francisco, Calif.; Quepasa® and MyYearBook® available from MeetMe, Inc. of New Hope, Pa.; Twitter® available from Twitter, Inc. of San Francisco, Calif.; Spotify® available from Spotify AB of Stockholm, Sweden; Pinterest® available from Pinterest, Inc. of Palo Alto, Calif., email services, address book services, etc.

The user 105 may have a user account registered in one or more of the above mentioned external services. The server 110 allows the user 105 to obtain the content items relevant to the user from the external services. In an embodiment, the server 110 obtains the user account credentials for a particular external service from the user, logs into that particular external service using the provided user account credentials and obtains the content items relevant to the user 105 from the particular external service using a published application programming interface (API) of the particular external service.

The content items of the user 105 obtained from the external services include (a) other users who are connected to the user in the external service, (b) content items shared with or posted or created by the user 105, (c) entities that are followed by user 105, (d) “likes” or comments by the user 105, etc.

In the example of FIG. 1, the storage system 115, the client 105, the server 110 and the external services run on one or more hosts (not shown). A host can be a computing device, a communication device, a storage device, or any electronic device capable of running a software, wherein the host contains at least a processor, a volatile storage (memory), and a non-volatile storage (not shown). For non-limiting examples, a host can be but is not limited to, a laptop PC, a desktop PC, a tablet PC, an iPod, a PDA, or a server machine. A storage device can be but is not limited to a hard disk drive, a solid state device such as a flash memory drive, or any portable storage device. A communication device can be but is not limited to a mobile phone.

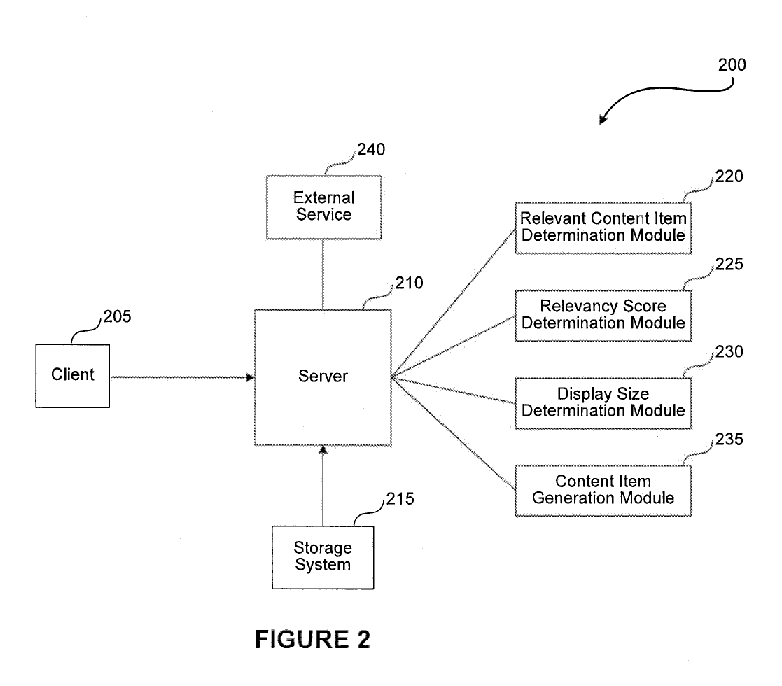

FIG. 2 is a block diagram illustrating a social network system 200 for generating content items with display sizes determined based on a relevancy score of the content items, according to an embodiment of the disclosed technique. The social networking system 200 may be operated in an environment such as environment 100 of FIG. 1. The social network system 200 includes a user such as client 205 consuming social networking services provided by a social network server 210. The user 205 may also access external service 240 which also provides social networking services or other similar services. The content items shared between various users in the social networking system 200 and other metadata regarding the content items can be stored in a storage system 215.

The social networking system 200 may contain a number of content items including a picture, an audio, a video, text, animation, a “like” by the user etc. For a user such as user 205, certain content items may be relevant and certain content items may not be relevant. For example, a picture posted by the user 205 or share with the user 205 may be relevant to the user 205, whereas a picture shared by another user with a friend of the user 205 may not be relevant to the user 205.

Further, even among the content items that are relevant to the user 205, some content items may be more relevant than other content items. For example, a first content item posted by the user 205 may be more relevant to the user 205 than a second content item shared by another user with the user 205. When the content items are presented to the user 205, the social networking system 200 presents the content items such that a size at which the content item is generated is proportional to the relevancy of the content item to the user 205. Considering the above mentioned example, when the user 205 is presented with the first and second content items, the first content item is displayed in a bigger size compared to the second content item. That is, the content items are resized based on a degree of relevance of the content items to a user. The social network system 200 determines a relevancy score for each of the content items and uses the relevancy score of a content item to determine a display size of the content item. The following paragraphs describe the process of resizing a content item based on its relevancy score.

A relevant content item module 220 working in cooperation with the server 210 determines the content items that are relevant to the user 205. The content items that are relevant to the user 205 includes, but is not limited to, the content items that the user may access in the social network system 200 with his/her user credentials. The relevant content item module 220 may also obtain content items that are relevant to the user 205 from external service 240. As mentioned above, the external service 240 may include social networking services such as, Facebook® available from Facebook of Menlo Park, Calif.; Google+® or g+® available from Google, Inc. of Mountain View, Calif., Tagged® available from Tagged, Inc. of San Francisco, Calif.; Quepasa® and MyYearBook® available from MeetMe, Inc. of New Hope, Pa.; Twitter® available from Twitter, Inc. of San Francisco, Calif.; Spotify® available from Spotify AB of Stockholm, Sweden; Pinterest® available from Pinterest, Inc. of Palo Alto, Calif. and email services, address book services, etc.

A relevancy score determination module 225 working in cooperation with the server 210 determines a relevancy score of each of the content items that are relevant to the user 205. The relevancy score of a content item is determined based on relevancy factors including (a) a direct interaction with the content item by the user, (b) an association of the content item with the user, (c) interaction with the content item by a first set of users who are in a social graph of the user, or (d) interaction with the content item by a second set of users who are not in the social graph of the user. Each of the above factors is assigned a different weight. Thus, each of the above factors has a varied impact on the final relevancy score determined for a content item. In an embodiment, the above relevancy factors are assigned weights in a descending order starting with relevancy factor (a) having the highest weight and relevancy factor (d) having the lowest weight.

In an embodiment, direct interaction or association of user 205 with a content item has a significant impact on the relevancy score. The direct interactions or associations can also be the ones that are from external service 240 in addition to social network service of server 210. The direct interactions from external service 240 may be captured, for example, via a published API of the external service 240.

The direct interaction with the content item by the user 205 includes at least one of (a) a creation of the content item by the user 205, (b) posting the content item in the social network by the user 205, (c) liking or marking the content item as favorite by the user 205, (d) commenting on the content item by the user 205, (e) sharing the content item with another user or another service, or (f) viewing the content item by the user 205. Further, the association of the content item with the user 205 includes an appearance of, mention of, or reference to the user 205 in the content item.

Each of these direct interactions has a different impact on the relevancy score of the content item. In interactions such as
Creating a content item—if a user 205 actually created the content item, whether on the social network service provided by the server 210 or external service 240, it is considered more relevant to the user 205 than the content items the user 205 did not create but posted to a collection on the social network service. For example, consider two pictures, one captured by the user 205 and another one captured by another user, posted by the user 205 to a collection in the social network system 200. The picture captured by the user 205 is considered more relevant to the user 205 than the one captured by another user. For content item that originated on the social network service provided by server 210, such as a note written within the social network service, the creator can be identified as the authenticated user who submitted the content. On the other hand, for content items originated on external service 240, the creator can be assigned as the content owner on the external service 240.
Appearing in the content item—if the user 205 is actually in a picture or video or mentioned in a text note or linked webpage, or tagged in a picture, the content item is considered more relevant to the user 205 than a content item in which the user 205 does not appear or is not mentioned. The appearance of a user may be determined using manual tagging, which identifies individuals within a content item such as picture, a video, etc., via face detection techniques or via other known techniques. The manual tags can be generated by the social network service or read from external service 240.
Posting the content item—The content item posted by user 205 to a collection may indicate that the content item is more relevant to the user 205 than content items posted to that same collection by other users.
Liking or favoriting the content item—A “like” of a content item or marking of a content item as favorite by the user 205 indicates that the content item is of special interest to the user 205. The liking or marking as favorite of the content item either on the social network service or on the external service 240 is considered to increase the relevancy score of that content item for the user 205. The Liking or favoriting data can be stored in the storage system 215. In an embodiment, the Liking or favoriting data can be stored in a separate table of a database than the content item itself and the liking or favoriting table can have a foreign key relationship with the content item table.
Commenting on the content item—Every time a user comments on a content item, either in the social network service or on external service 240 and regardless of whether that comment is posted in the social network service or on external service 240, the content item is considered to be more relevant to the user 205. The comments can be stored in a separate table of the storage system 215 than the content item itself and the comments table can have a foreign key relationship with the content item table.
Sharing the content item from the social network service to an external service 240—The content item shared by the user 205 is considered to be more relevant to the user 205 than the content that is not shared. The user 205 may share content items using, for example, a share button in the social network service provided by server 210. Such sharing allows for quicker posting of links to the content item to external service 240. It may also allow the user 205 to email a link to that content item through an email application. More services may be supported for direct sharing over time. Every time the user 205 shares a content item through the share button, the relevancy score of that content item is increased. A record of all sharing actions is stored in the storage system 215. The sharing actions may be stored separately from the content item table.
Viewing the content item—The more often the user 205 views a content item, the more relevant the content item is considered to be for the user 205. The view counts for a content item can be stored in the content table as a separate data field.

Further, in at least some embodiments, certain other interactions of the user 205 on content items in external service 240 may also be considered for determining a relevancy score of the content items.

The relevancy score of a content item for the user 205 may also be adjusted based on the interactions performed on the content items by entities other than user 205 such as, for example, users who are in a social graph of the user 205. The social graph of the user 205 may include (a) a set of users who are connected to the user 205 either in the social network service provided by the server 210 or in external service 240—for example, friends of the user 205 in Facebook; (b) a set of users in an address book of the user wherein the address book is provided by the social network service or external service 240—for example, contacts of the user 205 in Yahoo address book or Google Contacts, or (c) a set of users with whom the user has exchanged electronic mails.

The interactions performed by the users in the social graph of user 205 may be similar to or a subset of the direct interactions performed by the user 205 on the content items, mentioned above. While the interactions by users in the social graph of the user 205 are not as significant as direct interactions by the user 205, these interactions may be considered to impact that content item's relevancy to the user 205. Following are some examples of such interactions.
Creating a content item—If a content item is created by a user in the social graph of user 205, regardless of whether the content item is created on the social network service or external service 240, the content item is considered more relevant to the user 205 than content items created by users not in the social graph of user 205.
Appearing in the content item—If someone in the social graph of the user 205 is in a picture or video or mentioned in a text note or linked webpage, the content item is considered more relevant to the user 205 than the content item in which no one in the social graph of the user 205 appears or is mentioned.
Posting the content item—The content item posted by users in the social graph of the user 205 are considered more relevant to the user 205 than content items posted by users not in the social graph of the user 205.
Liking or favoriting the content item—The relevancy score of a content item is increased whenever users in the social graph of the user 205 like or favorite a content item.
Commenting on the content item—Every time users in the social graph of the user 205 comment on a content item, regardless of whether that comment is posted on the displaying service or other sites and services, the content item is considered more relevant to that user.
Sharing the content item—Every time users in the social graph of the user 205 shares a content item, for example, through a share button on that content item, the relevancy score of that content item for that user is increased.
Viewing the content item—The more often users in the social graph of the user 205 view a content item, the more relevant the content item is considered to be for the user 205.

Further, the value of the impact on the relevancy score from the same action by different users in the social graph of the user 205 may vary depending on a degree of like-mindedness between the user 205 and another user in the social graph. The higher the degree of like-mindedness, the greater is the impact of the actions of the other user on the relevancy of content items for each other.

The degree of like-mindedness between the user 205 and another user in the social graph is calculated based on at least one of the following:
Number of collections they are both contributors to—A contributor has the ability to post items to a collection in the social network service or the external service 240. If two users are both listed as contributors on the same collection, the users share a higher degree of like-mindedness;
Number of events the users attend together—Each time two users are listed as attending the same event, regardless of whether on the social network service or on external service 240, the users share a higher degree of like-mindedness;
Number of comments on each other's content items—Each time one user comments on a content item posted or created by another user, the users share a higher degree of like-mindedness;
Number of likes or favorites of each other's content items—Each time one user likes or favorites content by another user, the users share a higher degree of like-mindedness;
Number of services in which the users follow each other—The more external services 240 in which the two users are affiliated, the higher is the degree of like-mindedness between the users;
Number of group affiliations—The more groups two users belong to (for example, employers, schools), the higher is the degree of like-mindedness between the users; and
Direct relationships—Any direct relationship between two users (for example, if they are family members, or dating, or married), the higher is the degree of like-mindedness between the users.

Finally, the relevancy score of a content item for each user is also adjusted based on interaction with that content item by users not in the social graph of the user 205. While the interactions by the users not in the social graph of the user 205 are not assigned a weight as in interactions by the user 205 or by users in the user's social graph, such interactions are still considered to impact the relevancy of the content item. For example, the more users (including users not in the social graph of the user 205) interact with a content item, the more relevant the content item is considered to be to the user 205. Some of the interactions by users including users not in the social graph of the user 205 that increase the relevancy score of a content item are:
Likes or favorites of a content item by the users, either on the social network service provided by server 210 or external service 240;
Comments on the content item, either on the social network service provided by server 210 or external service 240;
Sharing of the content item either on the social network service provided by server 210 or external service 240; and
Views of the content item either on the social network service provided by server 210 or external service 240.

As can be appreciated from the foregoing, the relevancy score of a content item is determined and adjusted based on a number of factors, explained above, each of which has a different weight and hence, a varied impact on the relevancy score. The more relevant a content item is to a user, the higher would be a relevancy score of that content item to the user.

A display size determination module 230 working in cooperation with the server 210 determines a display size of a content item based on the relevancy score of the content item for the user 205. The higher the relevancy score of a content item to user 205, the larger the content item is displayed to the user 205. Displaying a content item with a higher relevancy score in a larger size than the content items with a lower relevancy score can be manifested in different ways depending on where the item is displayed to the user.

For example, in a display where multiple content items such as, for example, pictures, are displayed alongside each other and the dimensions of each picture is variable, the size of each picture can vary directly with the relevancy score. In a display where multiple content items are displayed together but all the pictures need to fit into a predetermined canvas size, content items can take on one of several predetermined picture sizes depending on their relative relevancy score. For example, if a canvas can only have pictures that fit into three predetermined sizes such as, large, medium, and small, each content item would be displayed at one of those sizes depending on where the relevancy score for that content item falls in the distribution of relevancy scores for all content items displayed. In an embodiment, if the relevancy score of all the content items for the user 205, ranges between 1 and 10, then the display size determination module 230 can determine that content items with relevancy score 1-4 are displayed at small size, content items with relevancy score 5-7 are displayed at medium size and content items with relevancy score 8-10 are displayed at large size.

After the display size determination module 230 determines the display size of all the content items for the user 205, a content item generation module 235 working in cooperation with the server 210 generates the content items in the determined display sizes for the user 205. The content items may be generated onto an output device such as a monitor of an electronic device, a print out. etc.

In the example of FIG. 2, although the components are depicted as functionally separate, such depiction is merely for illustrative purposes. It will be apparent to those skilled in the art that the components portrayed in this figure can be arbitrarily combined or divided into separate components.

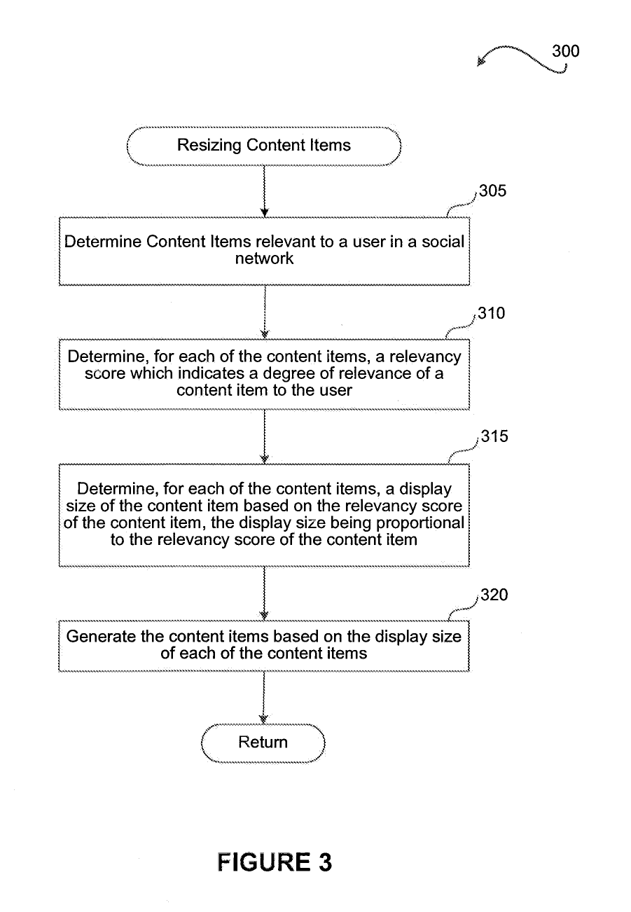

FIG. 3 is a flow diagram illustrating a process 300 for generating content items with display sizes determined based on a relevancy score of the content items, according to an embodiment of the disclosed technique. The process 300 can be executed in a system such as social network system 200 of FIG. 2. At step 305, the server 210 (or the relevant content item determination module 210) determines the relevant content items to the user. At step 310, the server 210 (or the relevancy score determination module 225) determines, for each of the content items, a relevancy score which indicates a degree of relevance of a content item to the user. The relevancy score is determined (and adjusted) based on a number of factors including interactions of various entities on the content items and type of interactions, and type of entities.

At step 315, the server 210 (or display size determination module 230) determines, for each of the content items, a display size of the content item based on the relevancy score of the content item. The display size of the content item can be directly proportional to the relevancy score of the content item. At step 320, the server 210 (or the content item generation module 235) generates the content items based on the display size of each of the content items.

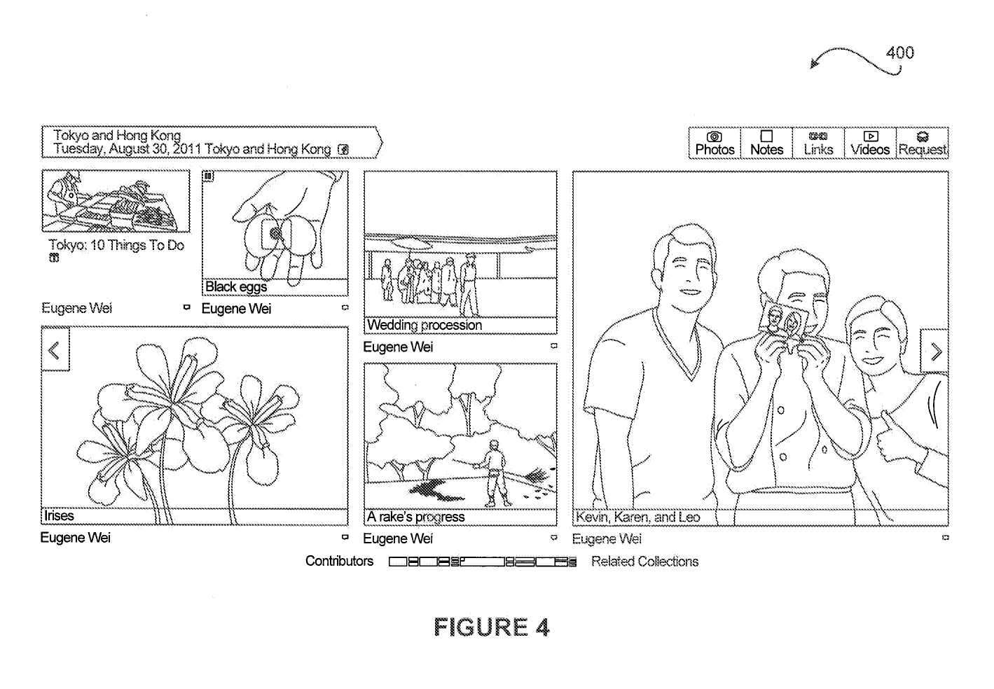

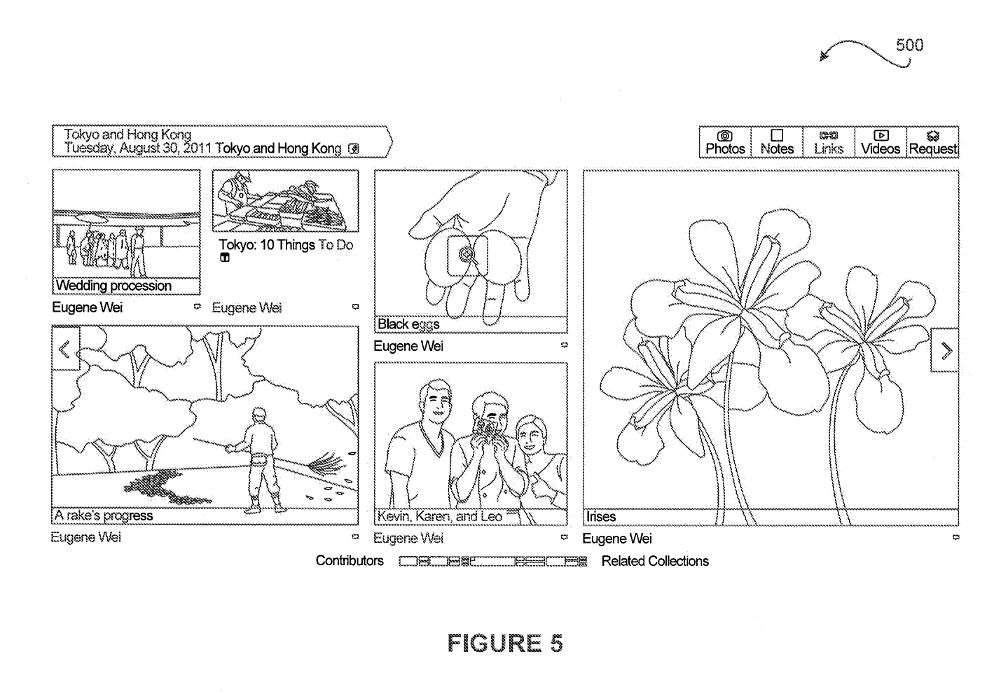

FIGS. 4 and 5 show how different users might see content items from a collection displayed at different sizes, according to an embodiment of the disclosed technique. Since the content items that may be relevant to one user may not be relevant to another user, relevancy of content items may differ from one user to another user. Therefore, relevancy score of the same content item may be different for different users. Accordingly, the same content item may be generated in different sizes for different users.

FIG. 4 illustrates a set of content items 400 generated for a user, for example, user A and FIG. 5 illustrates a set of content items 500 generated for another user, for example, user B. In the set of content items 400, the picture “Kevin, Karen, and Leo” is displayed at the largest size among all the pictures, which implies that the picture “Kevin, Karen, and Leo” is the most relevant to the user A among all the pictures in the set 400. The rest of the images are displayed in decreasing sizes implying that they are of lesser relevance than the image “Kevin, Karen, and Leo,” to the user A.

In the set of content items 500, the picture “Irises” is displayed at the largest size among all the pictures, which implies that the picture “Irises” is the most relevant among all the pictures in the set 500 to the user B. The rest of the images are displayed in decreasing sizes implying that they are of lesser relevance than the image “Irises,” to the user B.

The set of content items 400 and the set of content items 500 contain the same content items but in different display sizes. For example, the picture “Kevin, Karen, and Leo” is displayed in a larger size in FIG. 4 to user A than it is displayed to user B in FIG. 5, which implies that the image is more relevant to user A than to user B. On the other hand, the picture “Irises” is displayed in a larger size in FIG. 5 for user B than it is displayed to user A in FIG. 4, which implies that the image is more relevant to user B than to user A. The picture “Tokyo: 10 Things To Do” is displayed in same size in FIG. 4 to user A as it is displayed to user B in FIG. 5, which implies that the image is of same relevance to both users A and B.

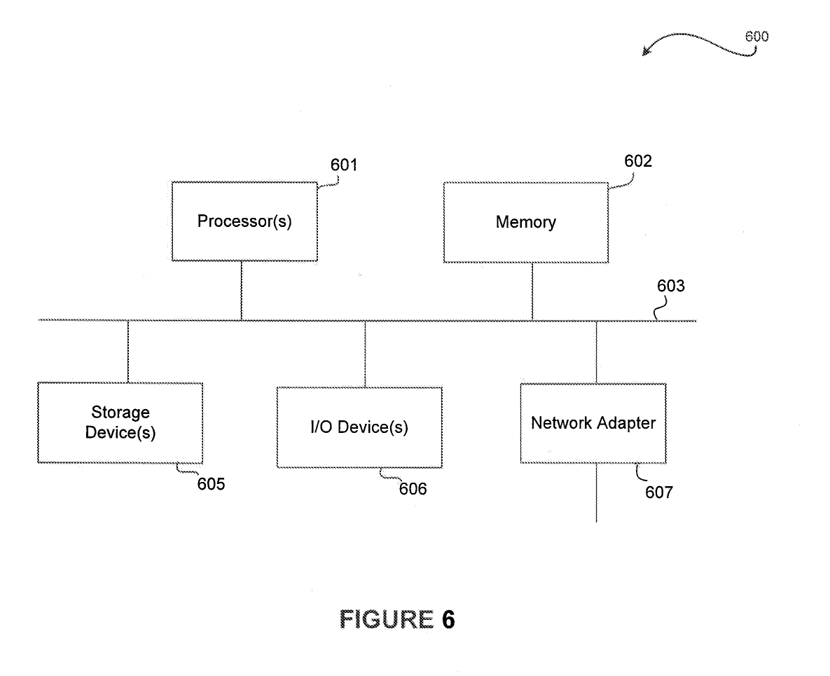

FIG. 6 is a block diagram of an apparatus that can perform various operations, and store various information generated and/or used by such operations, according to the disclosed technique. The apparatus can represent any computer described herein. The computer 600 is intended to illustrate a hardware device on which any of the entities, components or services depicted in the examples of FIGS. 1-5 (and any other components described in this specification) can be implemented, such as a social network service, a server, client, databases, etc. The computer 600 includes one or more processors 601 and memory 602 coupled to an interconnect 603. The interconnect 603 is shown in FIG. 6 as an abstraction that represents any one or more separate physical buses, point to point connections, or both connected by appropriate bridges, adapters, or controllers. The interconnect 603, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 601 is/are the central processing unit (CPU) of the computer 600 and, thus, control the overall operation of the computer 600. In certain embodiments, the processor(s) 601 accomplish this by executing software or firmware stored in memory 602. The processor(s) 601 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 602 is or includes the main memory of the computer 600. The memory 602 represents any form of random access memory (RAM), read-only memory (ROM), flash memory, or the like, or a combination of such devices. In use, the memory 602 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 601 through the interconnect 603 are a network adapter 607, a storage device(s) 605 and I/O device(s) 606. The network adapter 607 provides the computer 600 with the ability to communicate with remote devices, over a network and may be, for example, an Ethernet adapter or Fibre Channel adapter. The network adapter 607 may also provide the computer 600 with the ability to communicate with other computers within the cluster. In some embodiments, the computer 600 may use more than one network adapter to deal with the communications within and outside of the cluster separately.

The I/O device(s) 606 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 602 can be implemented as software and/or firmware to program the processor(s) 601 to carry out actions described above. In certain embodiments, such software or firmware may be initially provided to the computer 600 by downloading it from a remote system through the computer 600 (e.g., via network adapter 607).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 605 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state

The term “logic”, as used herein, can include, for example, programmable circuitry programmed with specific software and/or firmware, special-purpose hardwired circuitry, or a combination thereof.

What is claimed is:

1. A computer-implemented method for organizing content in a social network, the method comprising:
determining, for a user in the social network, a plurality of content items relevant to the user;
determining, for each of the content items, a relevancy score of a content item, the relevancy score indicating a degree of relevance of the content item to the user;
determining, for each of the content items, a display size of the content item based on the relevancy score of the content item, the display size being proportional to the relevancy score of the content item; and
generating the content items based on the display size of each of the content items.

2. The computer-implemented method of claim 1, wherein the display size of the content item is directly proportional to the relevancy score of the content item.

3. The computer-implemented method of claim 1, wherein the user is a registered user of the social network.

4. The computer-implemented method of claim 1, wherein the relevancy score of the content item is determined based on relevancy factors including at least one of (a) a direct interaction with the content item by the user, (b) an association of the content item with the user, (c) interaction with the content item by a first set of users who are in a social graph of the user, or (d) interaction with the content item by a second set of users who are not in the social graph of the user.

5. The computer-implemented method of claim 4, wherein each of the relevancy factors are associated with a different relevancy score weight, and wherein the relevancy score is determined as a function of the relevancy score weights of the relevancy factors.

6. The computer-implemented method of claim 4, wherein the direct interaction with the content item by the user includes at least one of (a) a creation of the content item by the user, (b) posting the content item in the social network by the user, (c) liking or marking the content item as favorite by the user, (d) commenting on the content item by the user, (e) sharing the content item with another user or another service, or (f) viewing the content item by the user.

7. The computer-implemented method of claim 4, wherein the association of the content item with the user includes an appearance of, mention of, or reference to the user in the content item.

8. The computer-implemented method of claim 4, wherein the interaction by a first set of users who are in a social graph of the user includes at least one of (a) a creation of the content item by another user who is in the social graph of the user, (b) posting the content item in the social network by another user who is in the social graph of the user, (c) liking or marking the content item as favorite by another user who is in the social graph of the user, (d) commenting on the content item by another user who is in the social graph of the user, (e) sharing, by another user who is in the social graph of the user, the content item with another user or another service, or (f) viewing the content item by another user who is in the social graph of the user.

9. The computer-implemented method of claim 8, wherein the relevancy score is a function of a degree of like-mindedness between the user and another user in the social graph of the user whose interactions are considered.

10. The computer-implemented method of claim 9, wherein the degree of like-mindedness between the user and the another user is determined based on (a) relationship between the user and the another user, (b) a number of content items contributed by both the user and the another user, (c) a number of events attended by both the user and the another user, (d) a number of comments by one of the user and the another user on a content item posted by the other of the user and the another user, (e) a number of likes or favorites by one of the user and the another user on a content item posted by the other of the user and the another user, (f) a number of services in which the user and the another user follow each other, or (g) a number of groups to which both the user and the another user are affiliated.

11. The computer-implemented method of claim 4, wherein first set of users who are in the social graph of the user includes at least one of (a) a set of users who are connected to the user, the set of users being connected to user in the social network or in a different service, (b) a set of users in an address book of the user, the address book provided by the social network or a different service, or (c) a set of users with whom the user has exchanged electronic mails.

12. The computer-implemented method of claim 4, wherein the interaction by a second set of users who are not in the social graph of the user includes at least one of (a) liking or marking the content item as favorite, (b) commenting on the content item, (e) sharing the content item with other users or another service, or (f) viewing the content item.

13. The computer-implemented method of claim 12, wherein the interaction by the second set of users includes an interaction by the second set of users on the content item in the social network or in a service external to the social network.

14. The computer-implemented method of claim 1, wherein generating the content items based on the display size of each of the content item includes determining if a canvas into which the content items are generated has a plurality of predetermined content item sizes; and
responsive to a determination that a canvas has predetermined content item sizes,
assigning a relevancy score range for each of the predetermined content item sizes,
determining a predetermined content item size for a content item based on the relevancy score of the content item, and
generating the content item at the predetermined content item size.

15. An apparatus comprising:
a) a processor; and
c) a storage device storing processor executable instructions which, when executed by the processor, cause the processor to execute a process including:
determining, for each of a plurality of content items in a social network, a relevancy score for a content item, the relevancy score indicating a degree of relevance of the content item to a user in the social network;
determining, for each of the content items, a display size of the content item based on the relevancy score of the content item, the display size being directly proportional to the relevancy score of the content item; and
generating the content items based on the display size of each of the content items.

16. The apparatus of claim 15, wherein the user is a registered user of the social network.

17. The apparatus of claim 15, wherein the relevancy score of the content item is determined based on factors including at least one of (a) an interaction with the content item by an entity, or (b) an association of the content item with the entity.

18. The apparatus of claim 17, wherein the entity includes at least one of (a) the user in the social network, (b) a first set of users who are in a social graph of the user, or (c) a second set of users who are not in the social graph of the user.

19. The apparatus of claim 18, wherein the process of determining the relevancy score of the content item includes determining the relevancy score as a function of a relevancy score weight associated with a type of the entity, wherein the relevancy score weight associated with the user is higher than the relevancy score weight associated with the first set of users who are in the social graph of the user which is higher than the relevancy score weight associated with the second set of users who are not in the social graph of the user.

20. The apparatus of claim 17, wherein the interaction with the content item by the entity includes at least one of (a) a creation of the content item by the entity, (b) posting the content item in the social network by the entity, (c) liking or marking the content item as favorite by the entity, (d) commenting on the content item by the entity, (e) sharing the content item with another entity or another service, or (f) viewing the content item by the entity.

21. The apparatus of claim 17, wherein the association of the content item with the entity includes an appearance of, a mention of, or reference to the entity in the content item.

22. An apparatus for organizing content in a social network, the apparatus comprising:
a means for determining, for a user in the social network, a plurality of content items relevant to the user;
a means for determining, for each of the content items, a relevancy score which indicates a degree of relevance of a content item to the user, the determination based on relevancy factors including at least one of (a) an interaction with the content item by an entity, or (b) an association of the content item with the entity;
a means for determining, for each of the content items, a display size of the content item based on the relevancy score of the content item, the display size being proportional to the relevancy score of the content item; and
a means for generating the content items based on the display size of each of the content items.

23. The apparatus of claim 22, wherein the interaction with the content item by the entity includes at least one of (a) a creation of the content item by the entity, (b) posting the content item in the social network by the entity, (c) liking or marking the content item as favorite by the entity, (d) commenting on the content item by the entity, (e) sharing the content item with another entity or another service, or (f) viewing the content item by the entity.

24. The apparatus of claim 22, wherein the entity includes at least one of (a) the user in the social network, (b) a first set of users who are in a social graph of the user, or (c) a second set of users who are not in the social graph of the user.
